(19) United States
(12) Patent Application Publication
(10) Pub. No.: US 2019/0155655 A1
(43) Pub. Date: May 23, 2019

(54) RESOURCE ALLOCATION METHOD AND RESOURCE MANAGER

(71) Applicant: Huawei Technologies Co., Ltd., Shenzhen (CN)

(72) Inventors: Ruibin Sha, Shenzhen (CN); Meng Gao, Shanghai (CN)

(21) Appl. No.: 16/258,152

(22) Filed: Jan. 25, 2019

Related U.S. Application Data
(63) Continuation of application No. PCT/CN2017/096785, filed on Aug. 10, 2017.

(30) Foreign Application Priority Data
Dec. 28, 2016 (CN) 201611238245.3

(51) Int. Cl. G06F 9/50; G06F 9/52; G06F 9/38

(52) U.S. Cl. CPC G06F 9/5022; G06F 2209/5011; G06F 9/3877; G06F 9/52

(57) ABSTRACT

A resource allocation method and a resource manager in a multi-CPU system are provided. The resource manager divides resources in the system into one global resource pool and at least two local resource pools, where the local resource pools are in a one-to-one correspondence with CPUs. The resource manager receives a resource application request sent by a first CPU; determines a current mode of the global resource pool; and when the global resource pool is in a centralized mode, allocates a resource to the first CPU from the global resource pool. When there is a shortage of resources, the resource manager gathers, in the global resource pool, allocatable resources in the system. In this way, when CPUs request resources, the resource manager can allocate resources all from the global resource pool, so as to improve system resource utilization efficiency.

### CROSS-REFERENCE TO RELATED APPLICATIONS

This application is a continuation of International Application No. PCT/CN2017/096785 filed on Aug. 10, 2017, which claims priority to Chinese Patent Application No. 201611238245.3 filed on Dec. 28, 2016. The disclosures of the aforementioned applications are hereby incorporated by reference in their entireties.

### TECHNICAL FIELD

This application relates to the field of communications technologies, and in particular, to a resource allocation method and a resource manager.

### BACKGROUND

Software programs in various software systems usually use different types of resources, and these resources usually include process resources, memory resources, and the like. Therefore, it is necessary to manage various resources. Especially in a multi-CPU environment, whether resource management is proper and efficient directly affects performance and efficiency of an entire software system.

Currently, a resource manager is mostly used to improve resource utilization efficiency. The resource manager provides a specific quantity of resources. When an application on a CPU needs to use a resource, the CPU requests the resource manager to allocate a resource, and the resource manager allocates the resource to the CPU and identifies the allocated resource as busy. The resource identified as busy cannot be allocated again. When the application does not use the resource, the CPU returns the resource to the resource manager, and the resource manager identifies the reclaimed resource as idle. The resource identified as idle may be re-allocated.

In the multi-CPU environment, the resource manager divides resources into one global resource pool and a plurality of local resource pools. Because CPUs access the global resource pool concurrently, a CPU needs to request a lock when the CPU requests a resource in the global resource pool from the resource manager. When the resource manager allocates the resource in the global resource pool to the CPU, the resource manager identifies the allocated resource as busy, so that the allocated resource cannot be allocated again. When the CPU releases the resource, the resource manager identifies the resource released by the CPU as idle, and the resource re-participates in resource allocation. Each CPU is associated with one local resource pool. When an application on the CPU needs to use a resource, the CPU requests a resource from a local resource pool associated with the CPU, and when the application on the CPU does not need the resource, the CPU releases the resource to the local resource pool. In this way, the CPU does not need to request the resource from the global resource pool, thereby reducing locking overheads and improving performance of a resource system. When the local resource pool has no resource for allocation, the resource manager allocates a specific quantity of resources to the local resource pool from the global resource pool. After the local resource pool reclaims a specific quantity of resources, the resource manager releases the reclaimed resources to the global resource pool. A quantity of resources in the local resource pool is related to load of the CPU associated with the local resource pool. If resources reserved in the local resource pool are excessive, a quantity of resources reserved in another local resource pool is affected, and even resources in the global resource pool are insufficient, thereby directly affecting system performance and availability; if resources reserved in the local resource pool are insufficient, the CPU needs to frequently request resources from the global resource pool, thereby increasing system overheads.

When the local resource pool has no resource for allocation, the CPU requests the resource manager to allocate a fixed quantity of M resources to the local resource pool from the global resource pool once; and after M resources are reclaimed in the local resource pool, the M resources are released to the global resource pool once. When an application on a CPU needs to use few resources, M resources in a local resource pool are relatively surplus, and resource utilization is not high. An application on another CPU probably needs to use a large quantity of resources, and in this case, M resources in a local resource pool corresponding to the CPU are insufficient, and the CPU needs to request or even repeatedly request a resource from the global resource pool. Consequently, normal running of the application on the CPU is affected. Therefore, when resource load of CPUs varies significantly, some local resource pools frequently request resources from the global resource pool, and some local resource pools have idle resources, thereby affecting system performance. In addition, when resources in the global resource pool are insufficient, resources in some local resource pools are surplus, and some local resource pools have no resources available, thereby further causing resource isolation and affecting system availability.

### SUMMARY

This application provides a resource allocation method and a resource manager. A mode of a global resource pool is adjusted based on a usage status of resources in a system, and a manner of allocating a resource to a CPU is determined based on the mode of the global resource pool. By using the resource allocation method provided in this application, resource allocation flexibility can be improved, resources can be allocated properly under different load pressures, and resource utilization can be improved.

According to a first aspect, a resource manager in a multi-CPU system is provided. The resource manager divides resources in the system into one global resource pool and at least two local resource pools, where the local resource pools are in a one-to-one correspondence with CPUs, and the resource manager is configured to: receive a resource application request sent by a first CPU; determine a current mode of the global resource pool; and when the global resource pool is in a centralized mode, allocate a resource to the first CPU from the global resource pool, where when the global resource pool is in the centralized mode, allocatable resources are in the global resource pool.

In this embodiment of this application, the global resource pool may be in different modes based on load pressures of the system. When there is a shortage of resources, the resource manager gathers, in the global resource pool, the allocatable resources in the system. In this way, when CPUs request resources, the resource manager can allocate resources all from the global resource pool, so as to improve utilization efficiency of system resources.

In a possible design, the resource manager is further configured to: when the global resource pool is in a distributed mode, allocate a resource to the first CPU from a first local resource pool corresponding to the first CPU, where when the global resource pool is in the distributed mode, the first local resource pool has an allocatable resource.

For different pressures in the system, the global resource pool is in different modes. When the resources in the system are sufficient, an allocatable resource may be reserved in the local resource pool to increase a response speed of the system and increase flexibility of the system.

In a possible design, the resource manager is further configured to: when the allocatable resource in the first local resource pool cannot meet a requirement of the first CPU, allocate a resource to the first local resource pool from the global resource pool, and then allocate a resource to the first CPU from the first local resource pool.

When the resources in the system are sufficient and there is a shortage of resources in the local resource pool, the resource manager may allocate a resource to the local resource pool from the global resource pool. In this way, the resource manager is applicable to different load pressures of the local resource pool, so as to improve system resource utilization.

In a possible design, the resource manager is further configured to: monitor a usage status of resources in the global resource pool; and when a quantity of allocatable resources in the global resource pool is less than a preset threshold, set the global resource pool to the centralized mode, reclaim unallocated resources in the at least two local resource pools in the system, and place the unallocated resources in the global resource pool.

The resource manager further needs to monitor the usage status of the resources in the global resource pool. When the resources are insufficient, an allocatable resource is reclaimed from the local resource pool to avoid a case in which some local resource pools have remaining resources while some local resource pools have no resource available, thereby improving the system resource utilization and improving availability of the system.

In a possible design, the resource manager is further configured to: monitor a usage status of resources in the local resource pool; and when a quantity of allocatable resources in the local resource pool is less than a preset value and when the global resource pool is in the distributed mode, allocate resources to the at least two local resource pools from the global resource pool.

In a possible design, the resource manager is further configured to: when a quantity of allocatable resources in the local resource pool is greater than a preset value, reclaim some resources of the allocatable resources in the local resource pool, and place the resources in the global resource pool.

The resource manager may further monitor the usage statuses of resources in the global resource pool and the local resource pool, actively allocate resources from the global resource pool to the local resource pool, or reclaim a resource from the local resource pool and place the resource in the global resource pool, so as to adapt to different load statuses and improve a usage rate of system resources.

In a possible design, the resource manager determines a quantity of allocated resources or a quantity of reclaimed resources according to a resource balancing algorithm.

In the resource balancing algorithm, a quantity of resources allocated by the resource manager to a local resource pool from the global resource pool or a quantity of resources reclaimed from the local resource pool may be calculated based on a current resource usage status. In this way, when the resource manager adjusts resource distribution, a quantity of adjusted resources may be adjusted based on different load of the system, thereby improving utilization of the resources in the system.

According to a second aspect, a resource allocation method in a multi-CPU system is provided, where the multi-CPU system includes a resource manager. The resource manager divides resources in a system into one global resource pool and at least two local resource pools, where the local resource pools are in a one-to-one correspondence with CPUs, and the method includes: receiving, by the resource manager, a resource application request sent by a first CPU; determining a current mode of the global resource pool; and when the global resource pool is in a centralized mode, allocating a resource to the first CPU from the global resource pool, where when the global resource pool is in the centralized mode, allocatable resources are in the global resource pool.

In a possible design, when the global resource pool is in a distributed mode, the resource manager allocates a resource to the first CPU from a first local resource pool corresponding to the first CPU, where when the global resource pool is in the distributed mode, the first local resource pool has an allocatable resource.

In a possible design, when the allocatable resource in the first local resource pool cannot meet a requirement of the first CPU, the resource manager allocates a resource to the first local resource pool from the global resource pool, and then allocates a resource to the first CPU from the first local resource pool.

In a possible design, the resource manager monitors a usage status of resources in the global resource pool;

and when a quantity of allocatable resources in the global resource pool is less than a preset threshold, the resource manager sets the global resource pool to the centralized mode, reclaims an unallocated resource in the local resource pool in the system, and places the unallocated resource in the global resource pool.

In a possible design, the resource manager monitors a usage status of resources in the local resource pool;

and when a quantity of allocatable resources in the local resource pool is less than a preset value and when the global resource pool is in the distributed mode, the resource manager allocates a resource to the local resource pool from the global resource pool.

In a possible design, when a quantity of allocatable resources in the local resource pool is greater than a preset value, the resource manager reclaims some resources of the allocatable resources in the at least two local resource pools, and places the resources in the global resource pool.

In a possible design, the resource manager determines a quantity of allocated resources or a quantity of reclaimed resources according to a resource balancing algorithm.

According to a third aspect, a resource manager in a multi-CPU system is provided, where the resource manager includes a processor, a communications bus, a memory, and a communications interface, and the processor is configured to execute the foregoing resource allocation method, and details are not described herein again.

In addition, for technical effects brought by any design manner of the second aspect and the third aspect, refer to the technical effects brought by different design manners of the first aspect. Details are not described herein again.

### BRIEF DESCRIPTION OF DRAWINGS

To describe the technical solutions in the embodiments of the present disclosure more clearly, the following briefly describes the accompanying drawings required for describing the embodiments.

FIG. 1 is a schematic structural diagram of a resource allocation system according to the present disclosure;

FIG. 2A is a schematic flowchart of a resource allocation method according to an embodiment of the present disclosure;

FIG. 2B is another schematic flowchart of a resource allocation method according to an embodiment of the present disclosure; and

FIG. 3 is a schematic structural diagram of a resource manager according to an embodiment of the present disclosure.

### DETAILED DESCRIPTION

The embodiments of the present disclosure provide a resource allocation method and system, and a resource manager in a multi-CPU system, and the resource allocation method and system, and the resource manager in the multi-CPU system can automatically adapt to a change in load on a CPU in the multi-CPU system, allocate a resource properly, improve system resource utilization, and improve system resource allocation and recycling performance, thereby improving performance and availability of the entire system.

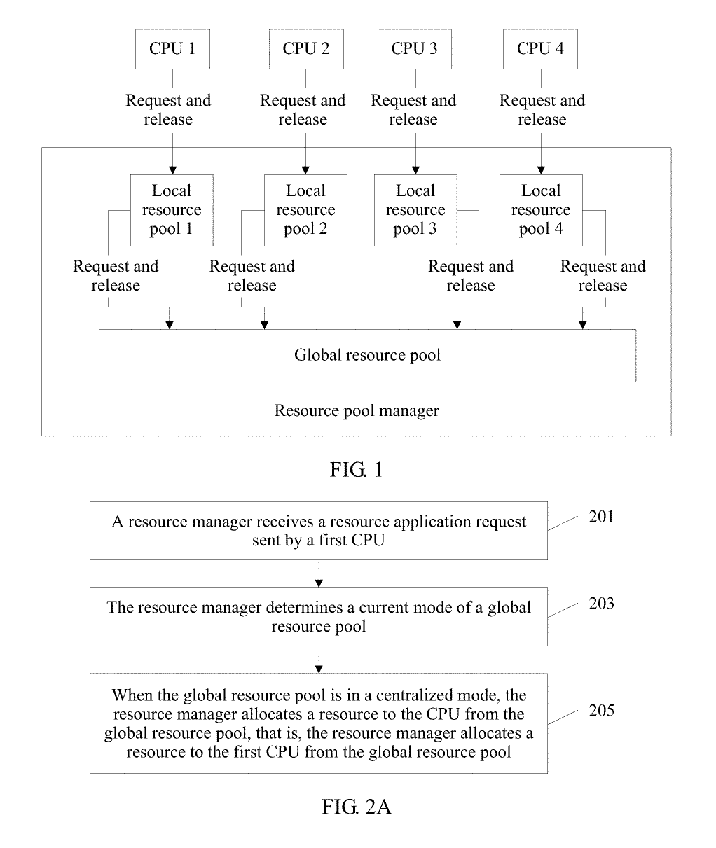

In the embodiments of the present disclosure, a resource is a resource allocated to an application on each CPU for use, such as a process resource, a memory resource, and the like. A structure of the resource allocation system in the embodiments of the present disclosure is shown in FIG. 1.

As shown in FIG. 1, a resource manager divides resources into one global resource pool and at least two local resource pools and is responsible for monitoring and managing a resource usage status. The local resource pools are in a one-to-one correspondence with CPUs. For example, a local resource pool 1 corresponds to a CPU 1, and a local resource pool 2 corresponds to a CPU 2, and so on. In FIG. 1, four CPUs and four local resource pools are provided as examples merely. In actual use, a quantity of CPUs and a quantity of corresponding local resource pools may be set based on a requirement.

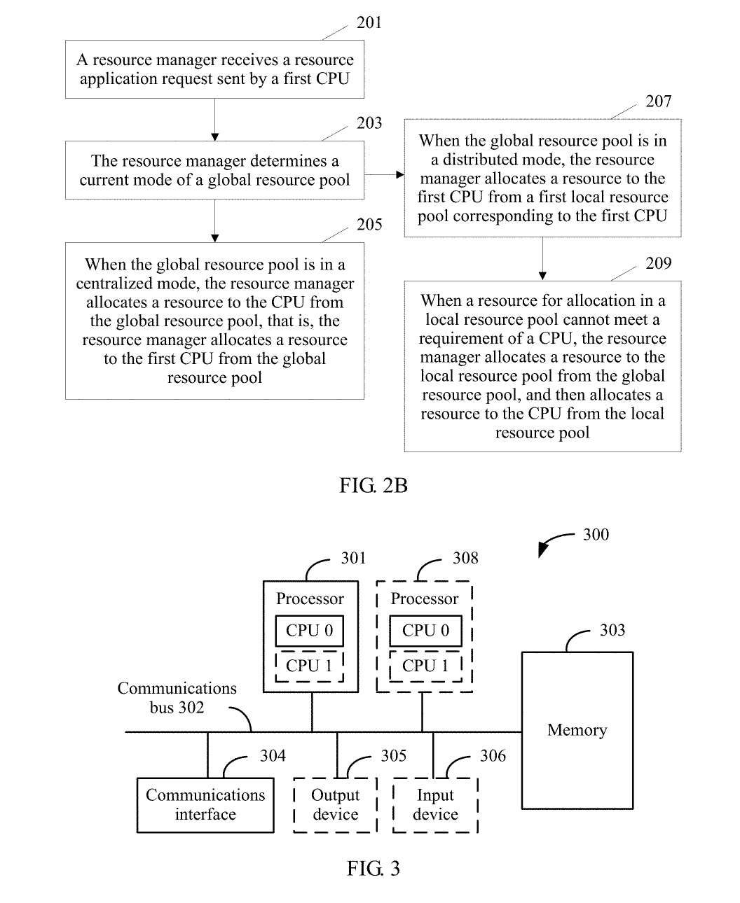

The resource allocation method provided in the embodiments of the present disclosure is described in detail in the following, as shown in FIG. 2A.

Step 201: A resource manager receives a resource application request sent by a first CPU.

When an application on a CPU needs to use a resource, the CPU sends a resource application request to the resource manager to request to allocate a resource. As an example for description, in this embodiment of the application, the resource manager receives the resource application request sent by the first CPU.

Step 203: The resource manager determines a current mode of a global resource pool. Step 205 or 207 continues to be performed.

In this embodiment of the present disclosure, the resource manager sets two modes for the global resource pool. One mode is a centralized mode, and the other mode is a distributed mode.

The resource manager monitors a usage status of resources in the global resource pool. When a quantity of allocatable resources in the global resource pool is less than a preset threshold, the resource manager sets the global resource pool to the centralized mode, reclaims unallocated resources in all local resource pools in a system, and places the unallocated resources in the global resource pool, so that remaining resources in the system are gathered in the global resource pool. In this embodiment of the present disclosure, a mode of the global resource pool in this state is referred to as the centralized mode.

When the quantity of allocatable resources in the global resource pool is greater than the preset threshold, the resource manager allocates a specific quantity of resources to a local resource pool, and in this case, remaining resources in the system are distributed in the global resource pool and the local resource pool. In this embodiment of the present disclosure, a mode of the global resource pool in this state is referred to as the distributed mode. The quantity of resources allocated by the resource manager to the local resource pool may be calculated by using a resource balancing algorithm provided in this embodiment of the present disclosure, and the resource balancing algorithm is described in the following.

The preset threshold herein is set based on load and a service type of the system, and is not limited in this embodiment of the present disclosure.

The usage status of the resources in the global resource pool may be determined based on a usage rate of the resources in the global resource pool. When the usage rate of the resources is greater than a preset threshold, the resource manager sets the global resource pool to the centralized mode, reclaims unallocated resources in all the local resource pools in the system, and places the unallocated resources in the global resource pool. When the usage rate of the resources in the global resource pool is less than the preset threshold, the resource manager allocates a specific quantity of resources to the local resource pool, and in this case, remaining resources in the system are distributed in the global resource pool and the local resource pool. Similarly, the threshold in this case may also be set based on an actual requirement.

Step 205: When the global resource pool is in a centralized mode, the resource manager allocates a resource to the CPU from the global resource pool, that is, the resource manager allocates a resource to the first CPU from the global resource pool.

It has been described in the above that when the global resource pool is in the centralized mode, the resource manager reclaims the unallocated resources in all the local resource pools in the system, and places the unallocated resources in the global resource pool. In this case, there is no resource for allocation in the local resource pools. In other words, when the global resource pool is in the centralized mode, allocatable resources in the system are all in the global resource pool. Therefore, the resource manager allocates the resource to the first CPU from the global resource pool. A quantity of resources allocated by the resource manager to the first CPU from the global resource pool may be calculated by using the resource balancing algorithm provided in this embodiment of the present disclosure.

After the resource allocated by the resource manager is received, the application on the CPU may run.

In addition to the foregoing steps, another embodiment of the present disclosure may further include the following steps, as shown in FIG. 2B. Step 207: When the global resource pool is in a distributed mode, the resource manager allocates a resource to the first CPU from a first local resource pool corresponding to the first CPU.

When the global resource pool is in the distributed mode, a local resource pool has an allocatable resource. When a quantity of allocatable resources in the global resource pool is greater than a preset threshold, the global resource pool has a relatively large quantity of allocatable resources, and each local resource pool has an allocatable resource. Therefore, when a CPU requests a resource, the resource manager allocates a resource to the CPU from a local resource pool corresponding to the CPU. A quantity of resources allocated by the resource manager to the first CPU from the first local resource pool corresponding to the first CPU may be calculated by using a resource balancing algorithm provided in this embodiment of the present disclosure.

In this case, the allocatable resource in the local resource pool probably cannot meet a requirement of the CPU. In this case, step 209 is performed.

Step 209: When an allocatable resource in a local resource pool cannot meet a requirement of a CPU, the resource manager allocates a resource to the local resource pool from the global resource pool, and then allocates a resource to the CPU from the local resource pool.

When the allocatable resource in the local resource pool cannot meet the requirement of the CPU, the resource manager allocates a specific quantity of resources to the local resource pool from the global resource pool, and then allocates the resource to the CPU from the local resource pool. The quantity of resources allocated by the resource manager to the local resource pool from the global resource pool may be calculated by using the resource balancing algorithm provided in this embodiment of the present disclosure. The resource balancing algorithm is described in detail in the following and is not described in this step.

When the allocatable resource in the local resource pool can meet the requirement of the CPU, the resource manager may allocate a resource to the CPU from the local resource pool.

In this embodiment of the present disclosure, when an allocatable resource in the first local resource pool cannot meet a requirement of the first CPU, the resource manager allocates a resource to the first local resource pool from the global resource pool, and then allocates a resource to the first CPU from the first local resource pool.

Optionally, this embodiment of the present disclosure may further include the following step:

the resource manager monitors a usage status of resources in the global resource pool, and when a quantity of allocatable resources in the global resource pool is less than a preset threshold, the resource manager sets the global resource pool to a centralized mode, reclaims an unallocated resource in the local resource pool in the system, and places the unallocated resource in the global resource pool; or

when a usage rate of resources in the global resource pool is greater than a preset threshold, the resource manager sets the global resource pool to a centralized mode, reclaims an unallocated resource in the local resource pool in the system, and places the unallocated resource in the global resource pool.

In this embodiment of the present disclosure, in order to improve resource allocation efficiency, it is ensured that a resource can be allocated from the global resource pool when the local resource pool needs the resource. Therefore, when the quantity of allocatable resources in the global resource pool is less than the preset threshold or the usage rate of the resources in the global resource pool is greater than a threshold, the resource manager needs to reclaim the unallocated resource in the local resource pool in the system, and place the unallocated resource in the global resource pool for management and allocation at the same location.

Optionally, the method may further include the following step:

the resource manager monitors a usage status of resources in the local resource pool, and when the quantity of allocatable resources in the local resource pool is less than a preset value, and when the global resource pool is in the distributed mode, the resource manager allocates a resource to the local resource pool from the global resource pool.

In this embodiment of the present disclosure, the resource manager may further monitor the usage status of the resources in the local resource pool in the system. When the global resource pool is in the distributed mode and the quantity of allocatable resources in the local resource pool is less than a specific quantity, the resource manager may actively allocate a resource to the local resource pool. The quantity of resources allocated by the resource manager to the local resource pool from the global resource pool may be calculated by using the resource balancing algorithm provided in this embodiment of the present disclosure.

In this way, the allocatable resources in the local resource pool can be sufficient. When an application on the CPU corresponding to the local resource pool needs to use a resource, a resource may be directly allocated for the application on the CPU from the local resource pool, thereby improving efficiency.

Optionally, this embodiment of the present disclosure may further include the following step:

when the quantity of allocatable resources in the local resource pool is greater than the preset value, the resource manager reclaims some resources of the allocatable resources in the local resource pool, and places the resources in the global resource pool.

When the quantity of allocatable resources in the local resource pool is greater than a specific value and the allocatable resources in the local resource pool are surplus, the resource manager reclaims some of the allocatable resources, and places the resources in the global resource pool. In this way, when a local resource pool needs a resource, the resource manager can allocate a resource to the local resource pool from the global resource pool. The preset value of the quantity of allocatable resources in the local resource pool is set based on a service requirement, and is not limited in this embodiment of the present disclosure.

A quantity of resources reclaimed by the resource manager from the local resource pool may be calculated by using the resource balancing algorithm provided in this embodiment of the present disclosure. Alternatively, a quantity of allocatable resources that is obtained by subtracting the preset value from a quantity of all the allocatable resources in the local resource pool may be reclaimed. Alternatively, a fixed quantity of allocatable resources in the local resource pool may be reclaimed.

The resource manager may set a minimum quantity of reserved resources for each local resource pool, or may not reserve any resource for the local resource pool, and this may be determined based on a specific service and a requirement.

This embodiment of the present disclosure provides an idea of a resource allocation method. It may be understood that, in actual application, the resource manager may also manage local resource pools for different services. In this way, the local resource pools correspond to the services in the system, and allocation of resources by the resource manager is consistent with the idea of the resource allocation method provided in this embodiment of the present disclosure, and this is not described separately.

In this embodiment of the present disclosure, the resource balancing algorithm is provided, and the resource balancing algorithm is used to determine a quantity of allocated resources when the resource manager allocates a resource to a local resource pool from a global resource pool, or may be used to determine a quantity of reclaimed resources when the resource manager reclaims an allocatable resource in the local resource pool. Determining an appropriate quantity of allocated resources and an appropriate quantity of reclaimed resources can minimize a time for responding to the CPU. Therefore, when the resource manager allocates a resource to a local resource pool and reclaims a resource from a local resource pool, the resource balancing algorithm needs to be used to calculate the quantity of allocated resources or the quantity of reclaimed resources.

Parameters involved in the resource balancing algorithm are as follows:

A sampling period T: The sampling period may also be referred to as sampling duration, and allocation of resources in a local resource pool is monitored in the sampling period. A specific value may be set by a user based on a requirement. Generally, in order to respond to a resource application request of a CPU in time, the sampling period is not set to be excessive long, and may be set within an acceptable range of the user.

A time aₙ consumed by the CPU for requesting a resource in an n^{th} sampling period: duration consumed by the CPU from requesting a resource to obtaining an allocated resource in the sampling period. This value is subject to measured data.

A sampling window size m: a quantity of sampling periods in a continuous sampling time. This value is set by the user based on a requirement.

A weight r (0<r<1) for calculating a time consumed by a CPU for requesting a resource: a weight for calculating a time consumed by each resource application request for requesting a resource in a continuous sampling period. The weight is set based on a requirement of the user. Generally, when recently sampled data is more trusted, a weight for calculating a time consumed is larger.

Duration t consumed by a CPU for requesting a lock of a resource in a sampling period: This value is subject to measured data. To avoid a resource conflict, a lock is used in this embodiment of the present disclosure, and a specific implementation is the same as that in the prior art. A new lock technology may also be used, provided that a resource allocation conflict can be avoided. This is not further described in the present disclosure.

In the resource balancing algorithm provided in this embodiment of the present disclosure, an intermediate variable: a weighted time Sn consumed by a resource application request for requesting a resource in sampling duration needs to be calculated first.

According to a convolution calculation formula the

$$x ( n ) * h ( n ) = {\sum }_{m = - ∞}^{∞} x ( m ) h ( h - m ) ,$$

following method for calculating Sn may be obtained:

$${S}_{n} = ( 1 - r ) * ( {a}_{n} + {ra}_{n - 1} + {r}^{2} {a}_{n - 2} + {r}^{3} {a}_{n - 3} + … + {r}^{m - 1} {a}_{n - m + 1} )$$

$${S}_{n + 1} = ( 1 - r ) * ( {a}_{n + 1} + {ra}_{n} + {r}^{2} {a}_{n - 1} + {r}^{3} {a}_{n - 2} + … + {r}^{m - 1} {a}_{n - m + 2} ) = ( 1 - r ) ( {a}_{n + 1} + r [ \frac{{S}_{n}}{1 - r} + {r}^{m - 2} {a}_{n - m + 2} ] )$$

$${S}_{n + 1} \approx ( 1 - r ) {a}_{n + 1} + {rS}_{n}$$

A quantity K of resources that are allocated to a local resource pool in the sampling duration may be obtained according to a return on investment ratio model. According to the return on investment ratio model:

$$( {K}_{n + 1} - {K}_{n} ) / ( \frac{T}{T - t} {S}_{n} - {S}_{n} ) = ( {K}_{n} - {K}_{n - 1} ) / ( {S}_{n} - {S}_{n - 1} ) , \\ {K}_{n + 1} = ( {K}_{n} - {K}_{n - 1} ) / ( {S}_{n} - {S}_{n - 1} ) * ( \frac{T}{T - t} {S}_{n} - {S}_{n} ) + {K}_{n} .$$

Note: The time weighted consumption generated by a resource user in a first sampling window is S₁=0; and a quantity of resources allocated in a zeroth sampling window is K₁=0, and a quantity of resources allocated in the first sampling window is K₂=0.

By using the resource balancing algorithm provided in this embodiment of the present disclosure, the resource manager calculates, based on a specified time period, a quantity of resources to-be-allocated to each local resource pool. When a resource needs to be allocated to a local resource pool, for example, when an allocatable resource in the local resource pool cannot meet a requirement of a CPU, the resource manager allocates a resource to the local resource pool based on a current quantity of resources to-be-allocated to the local resource pool. When a quantity of allocatable resources in the local resource pool is greater than the preset value, and when the resource manager needs to reclaim a resource from the local resource pool, a quantity of reclaimed resources may also be determined according to the resource balancing algorithm.

The embodiments of this application further provide a resource manager, configured to manage resources in a multi-CPU system. The resource manager divides the resources in the system into one global resource pool and at least two local resource pools, and the at least two local resource pools are in a one-to-one correspondence with CPUs, as shown in FIG. 1.

The resource manager is configured to: receive a resource application request sent by a first CPU; determine a current mode of the global resource pool; and when the global resource pool is in a centralized mode, allocate a resource to the first CPU from the global resource pool, where when the global resource pool is in the centralized mode, allocatable resources in the system are in the global resource pool.

The resource manager is further configured to: when the global resource pool is in a distributed mode, allocate a resource to the first CPU from a first local resource pool corresponding to the first CPU, where when the global resource pool is in the distributed mode, the first local resource pool has an allocatable resource.

The resource manager is further configured to: when the allocatable resource in the first local resource pool cannot meet a requirement of the first CPU, allocate a resource to the first local resource pool from the global resource pool, and then allocate a resource to the first CPU from the first local resource pool.

When allocating a resource to the local resource pool from the global resource pool, the resource manager may determine a quantity of allocated resources according to the foregoing resource balancing algorithm, which is not described herein again. The resource balancing algorithm provided in this embodiment of this application may be adjusted based on load of the CPU, and allocation and usage statuses of resources in the system. Therefore, a quantity of resources allocated by the resource manager to the local resource pool may vary from time to time, thereby improving availability of the system resources.

The resource manager is further configured to: monitor a usage status of resources in the global resource pool; and when a quantity of allocatable resources in the global resource pool is less than a preset threshold, set the global resource pool to the centralized mode, reclaim an unallocated resource in the local resource pool in the system, and place the unallocated resource in the global resource pool.

When the resource manager needs to reclaim a resource in the local resource pool, a quantity of reclaimed resources may also be determined according to the foregoing resource balancing algorithm. The quantity of reclaimed resources that is determined by the resource manager according to the resource balancing algorithm may dynamically change, so as to better adapt to a change of a requirement of the CPU in the system and improve flexibility of system resource application.

The resource manager is further configured to: monitor a usage status of resources in the local resource pool; and when a quantity of allocatable resources in the local resource pool is less than a preset value and when the global resource pool is in the distributed mode, allocate the resource to the local resource pool from the global resource pool.

The resource manager is further configured to: when the quantity of allocatable resources in the local resource pool is greater than the preset value, reclaim some resources of the allocatable resources in the at least two local resource pools, and place the resources in the global resource pool.

According to the resource manager provided in this embodiment of this application, dynamic adjustment may be performed based on a usage status of resources in the system. When the allocatable resources in the global resource pool are insufficient, the allocatable resource in the local resource pool is reclaimed and placed in the global resource pool for allocation and management at the same location. When allocatable resources in the global resource pool are excessive, a resource can be allocated to a local resource pool by using a resource balancing mechanism, so as to respond to a requirement of a CPU more quickly.

With reference to units and algorithm steps of each example described in the embodiments disclosed in this application, this application can be implemented in a form of hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

FIG. 3 is a schematic diagram of a hardware structure of a resource manager according to an embodiment of this application. The resource manager 300 includes at least one processor 301, a communications bus 302, a memory 303, and at least one communications interface 304.

The processor 301 may be a central processing unit (CPU), a microprocessor, an application-specific integrated circuit (ASIC), or one or more integrated circuits configured to control program execution of the solution in this application.

The communications bus 302 may include a channel in which information is transmitted between the foregoing components.

The communications interface 304 may be any apparatus like a transceiver, and is configured to communicate with another device or communications network, such as the Ethernet, a radio access network (RAN), a wireless local area network (WLAN), or the like.

The memory 303 may be a read-only memory (ROM) or another type of static storage device capable of storing static information and a static instruction, or a random access memory (RAM) or another type of dynamic storage device capable of storing information and an instruction, or may be an electrically erasable programmable read-only memory (EEPROM), a compact disc read-only memory (CD-ROM), or another compact disc storage, an optical disc storage (including a compressed optical disc, a laser disc, an optical disc, a digital versatile disc, a Blu-ray optical disc, and the like), a disk storage medium, another magnetic storage device, or any other medium capable of carrying or storing expected program code in a form of an instruction or a data structure and capable of being accessed by a computer, but is not limited thereto. A memory may exist independently and is connected to a processor by using a bus. The memory may also be integrated with the processor.

The memory 303 is configured to store application program code that executes the solution in this application, and the processor 301 controls execution of the solution in this application. The processor 301 is configured to execute the application program code stored in the memory 303, so as to implement a resource allocation method in a multi-CPU system in the foregoing embodiment.

In a specific implementation, as an embodiment, the processor 301 may include one or more CPUs, for example, a CPU 0 and a CPU 1 in FIG. 3.

In a specific implementation, as an embodiment, the resource manager 300 may include a plurality of processors, for example, the processor 301 and a processor 308 in FIG. 3. Each of these processors may be a single-core processor or may be a multi-core processor. The processor herein may be one or more devices, circuits, and/or power processor units configured to process data (for example, a computer program instruction).

In a specific implementation, as an embodiment, the resource manager 300 may further include an output device 305 and an input device 306. The output device 305 communicates with the processor 301, and may display information in a plurality of manners. For example, the output device 305 may be a liquid crystal display (LCD), a light emitting diode (LED) display device, a cathode-ray tube (CRT) display device, a projector, or the like. The input device 306 communicates with the processor 301, and may receive an input of a user in a plurality of manners. For example, the input device 306 may be a mouse, a keyboard, a touchscreen device, or a sensing device.

The resource manager 300 may be a general server unit or a dedicated server. In specific implementation, the resource manager 300 may be a desktop, a portable computer, a network server, a palmtop computer (PDA), a mobile phone, a tablet, a wireless terminal device, a communications device, an embedded device, or a device having a similar structure in FIG. 3. A type of the resource manager 300 is not limited in this embodiment of this application.

Because the resource manager provided by this embodiment of this application may be configured to perform the foregoing resource allocation method in the multi-CPU system, for a technical effect that can be obtained by the resource manager, refer to the foregoing method embodiment. Details are not described again herein.

The embodiments of the present disclosure further provide a computer storage medium, configured to store a computer software instruction used by the resource manager, and the computer software instruction includes a program designed for executing the foregoing method embodiment. By executing a stored program, the resource allocation method can be implemented in the multi-CPU system.

The embodiments of this application further provide a computer program, and the computer program includes an instruction. When the computer program is executed by a computer, the computer can perform the procedure in the foregoing method embodiment.

Although this application is described with reference to the embodiments, in a process of implementing this application that claims protection, a person skilled in the art may understand and implement another variation of the disclosed embodiments by viewing the accompanying drawings, disclosed content, and the accompanying claims. In the claims, the word “comprises” does not exclude other components or steps, and “a” or “one” does not exclude a plurality. A single processor or another unit may implement several functions enumerated in the claims. Some measures are recorded in dependent claims that are different from each other, but this does not mean that these measures cannot be combined to produce a better effect.

A person skilled in the art should understand that the embodiments of this application may be provided as a method, an apparatus (device), or a computer program product. Therefore, this application may use a form of hardware only embodiments, software only embodiments, or embodiments with a combination of software and hardware. Moreover, this application may use a form of a computer program product that is implemented on one or more computer usable storage media (including but not limited to a disk memory, a CD-ROM, an optical memory, and the like) that include computer usable program code. The computer program is stored/distributed in a proper medium and is provided as or used as a part of the hardware together with another hardware, or may be distributed in another form, for example, by using the Internet or another wired or wireless telecommunications system.

This application is described with reference to the flowcharts and/or block diagrams of the method, the apparatus (device), and the computer program product of the embodiment of this application according to this application. It should be understood that the computer program instructions may be used to implement each process and/or each block in the flowcharts and/or the block diagrams, and a combination of a process and/or a block in the flowcharts and/or the block diagrams. These computer program instructions may be provided for a general-purpose computer, a special-purpose computer, an embedded processor, or a processor of any other programmable data processing device to generate a machine, so that the instruction executed by the computer or the processor of any other programmable data processing device generates an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the programmable device, thereby generating computer-implemented processing. Therefore, the instructions executed on the computer or the other programmable device provide steps for implementing a specific function in one or more processes in the flowcharts and/or in one or more blocks in the block diagrams.

Although this application is described with reference to specific features and the embodiments thereof, apparently, various modifications and combinations may be made to them without departing from the spirit and scope of this application. Correspondingly, the specification and accompanying drawings are merely example description of this application defined by the accompanying claims, and is considered as any of or all modifications, variations, combinations or equivalents that cover the scope of this application. Obviously, a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A multi-CPU system, comprising:
multiple central processing units (CPUs); and
a processor configured to:
group resources of the multi-CPU system into a global resource pool and a plurality of local resource pools, each of the local resource pools corresponding to a respective one of the multiple CPUs,
determine that a quantity of available resources in the global resource pool is below a preset threshold,
based on the determination, reclaim resources of each of the local resource pools into the global resource pool,
receive a first resource application request from a first CPU of the multiple CPUs, and
in response to the first resource application request, allocate a first resource to the first CPU from the global resource pool.

2. The system according to claim 1, wherein the processor is further configured to:
determine that the quantity of available resources in the global resource pool is above or equal to the preset threshold; and
based on the determination, distribute the available resources in the global resource pool to each of the local resource pools.

3. The system according to claim 2, wherein the processor is further configured to:
receive a second resource application request from a second CPU of the multiple CPUs; and
in response to the second resource application request, allocate a resource to the second CPU from a local resource pool corresponding to the second CPU.

4. The system according to claim 1, wherein the resources of each of the local resource pools are reclaimed into the global resource pool according to a resource balancing algorithm.

5. A method for allocating resources in a multi-CPU system, the method comprising:
grouping, by a processor, resources of the multi-CPU system into a global resource pool and a plurality of local resource pools, each of the local resource pools corresponding to a respective one of multiple central processing units (CPUs) within the multi-CPU system;
determining, by the processor, that a quantity of available resources in the global resource pool is below a preset threshold;
based on the determination, reclaiming, by the processor, resources of each of the local resource pools into the global resource pool;
receiving, by the processor, a first resource application request from a first CPU of the multiple CPUs; and
in response to the first resource application request, allocating, by the processor, a first resource to the first CPU from the global resource pool.

6. The method according to claim 5, further comprising:
determining, by the processor, that the quantity of available resources in the global resource pool is above or equal to the preset threshold; and
based on the determination, distributing, by the processor, the available resources in the global resource pools to each of the local resource pools.

7. The method according to claim 6, further comprising:
receiving, by the processor, a second resource application request from a second CPU of the multiple CPUs; and
in response to the second resource application request, allocating, by the processor, a resource to the second CPU from a local resource pool corresponding to the second CPU.

8. The method according to claim 5, wherein the resources of each of the local resource pools are reclaimed into the global resource pool according to a resource balancing algorithm.
